(19) United States
(12) Patent Application Publication
(10) Pub. No.: US 2025/0077944 A1
(43) Pub. Date: Mar. 6, 2025

(54) DATA MODEL DEVELOPMENT STANDARDIZATION

(71) Applicant: Wells Fargo Bank, N.A., San Francisco, CA (US)

(72) Inventors: Krishnakumar Chellappa, Indian Land, SC (US); Nagender Akula, Nagole (IN); Abhishek Desai, Dumont, NJ (US); Sai Shashank Gubba, Hyderabad (IN); Amrith Kumar, Charlotte, NC (US); Subrat Padhi, Bilekahalli (IN); Murali Ravipudi, Nanakramguda (IN)

(21) Appl. No.: 18/456,777

(22) Filed: Aug. 28, 2023

(51) Int. Cl. G06N 20/00; G06F 8/35; G06F 9/54

(52) U.S. Cl. CPC G06N 20/00; G06F 8/35; G06F 9/54

(57) ABSTRACT

Building machine learning models using a standardized library of machine learning model tools. An Application Programming Interface (API) serves as an interface between one or more computer applications that receive user commands for building machine learning models and the standardized library of tools. The API provides an interface between data scientists tasked with designing machine learning models conceptually and a standardized set of software engineering tools. The API enables incorporation of the relevant standardized software engineering tools to build the machine learning models that have been designed conceptually by the data scientists.

### RELATED APPLICATION

This application relates to U.S. patent application Ser. No. 17/308,478 filed May 5, 2021 (the '478 Application), the contents of which are hereby incorporated by reference in their entirety.

### BACKGROUND

Enterprises use computer modeling, often in the form of machine learning models, to predict outcomes based on large quantities of data. The predicted outcomes can be used to create and modify products and services for customers, to communicate with customers and other parties, and so forth. Typically, large enterprises, such as financial institutions, will use data scientists and software engineers to build different machine learning models that are leveraged for different projects.

### SUMMARY

In general terms, the present disclosure is directed to a library storing modules that can be used to build different data models, such as machine learning models.

In further general terms, the present disclosure is directed to building standard data pipelines, integrating inferencing engines with machine learning models, and orchestrating and executing end to end machine learning operations pipelines using a library of stored modules and a software development kit (SDK) that includes tools for model developers to build machine learning models.

In further general terms, the present disclosure is directed to using, via an Application Programming Interface (API), a library of modules to build different machine learning models.

The API can be included in a specifically formulated SDK. In some examples, the SDK can be provided in a general-purpose programming language such as Python™.

The library is a standardized repository of machine learning model tools for different phases of a model development life cycle.

An aspect of the present disclosure relates to a computing system for generating models, includes: a processor; and memory encoding instructions which, when executed by the processor, cause the computing system to: store a library including modules, the modules being programmed to perform tasks of tools of different machine learning models; and incorporate different ones of the modules into the different machine learning models while the different machine learning models are being built, the different ones of the modules being incorporated into the different machine learning modules in response to different calls made via an Application Programming Interface (API), the API being an interface between the library and a computer application configured to receive commands for building the different machine learning models.

Another aspect relates to a method of generating computer-implemented models, including: storing a library including modules, the modules being programmed to perform tasks of tools of different machine learning models; and incorporating different ones of the modules into the different machine learning models while the different machine learning models are being built, the different ones of the modules being incorporated into the different machine learning modules in response to different calls made via an Application Programming Interface (API), the API being an interface between the library and a computer application configured to receive commands for building the different machine learning models.

Yet another aspect relates to computing system for generating models, including: a processor; and memory encoding instructions which, when executed by the processor, cause the computing system to: store a library including modules, the modules being programmed to perform tasks of tools of different machine learning models, the library including: at least one first module configured to filter out and discard portions of input data while the different machine learning models are being built; at least one second module configured to convert different sets of input data having data formats into other data formats that can be processed by the machine learning models while the machine learning models are being built; at least one third module configured to identify variables from the different sets of input data that are relevant to determining predicted outcomes by the machine learning models while the machine learning models are being built; and at least one fourth module configured to measure performances of the different machine learning models while the different machine learning models are being built by comparing the predicted outcomes generated by the machine learning models being built to known data; and incorporate the modules into the different machine learning models while the different machine learning models are being built, the modules being incorporated into the different machine learning modules in response to different calls made via an Application Programming Interface (API), the API being an interface between the library and a computer application configured to receive commands for building the different machine learning models.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example machine learning model development method in accordance with the present disclosure.

FIG. 2 shows an example system for building machine learning models according to the present disclosure.

FIG. 3 shows details of an example library of the system of FIG. 2.

FIG. 4 shows a further example system for building machine learning models according to the present disclosure.

FIG. 5 shows an example method of building machine learning models according to the present disclosure.

FIG. 6 shows example physical components of portions of the system of FIG. 4.

### DETAILED DESCRIPTION

Enterprises, such as financial institutions, use computer models to predict outcomes. Such models use algorithms to process data. Increasingly, such models are machine learning models that generate and then use their own algorithms.

Conceptually, the basic objective and structure of a given machine learning model is typically conceived by data scientists. For example, a data scientist determines what a given model is going to be used for, e.g., the types of outcomes the model should predict. The data scientist can also determine the pool of data that will be fed to the model while the model is being built to train the model and subsequently to score the model. The data scientist can also determine the type or form of the model outputs.

Machine learning models generate algorithms using model tools that process large quantities of input data. The models use the model tools to determine parameters and hyperparameters for the models' algorithms. The models then tune the hyperparameters to improve the accuracy of the models' output predictions based on a given set of input data.

In a home mortgage context relating to appraisal of new homes for issuing mortgages, for example, the data scientist determines if the model is responsible for predicting that a new home is either in a flood zone or not in a flood zone, and/or for predicting a quantitative likelihood that a new home will flood from a weather event over the next 30 years. Whether a home is in a flood zone or is likely to flood can impact the home's valuation (e.g., for purposes of an appraisal and issuing of a mortgage), as well as other factors, such as whether flood insurance will be legally required to be purchased by the buyer as part of the purchase of the home.

Once the basic structure of the model is determined, the model is developed, or built. Machine learning model development is typically a multi-phase process. The basic phases include a training phase, a scoring phase, and a post-scoring phase. Once the post-scoring phase is complete, the machine learning model can undergo further testing and approval before it is ultimately deployed in a production environment. Once deployed, the enterprise can then rely on the built model's outputs to make various decisions.

During the training phase, the model being built is trained, typically based on existing data with known outcomes. For example, a model being built to predict whether new homes and buildings will be in flood zones is fed data about existing homes and data indicating whether those existing homes are, or are not, in flood zones.

During the scoring phase, the performance of a machine learning model being built is measured by comparing predicted outcomes generated by the model being built to known data. For example, during the scoring phase the model being built is fed input data that it did not have access to during the training session with known outcomes (e.g., an additional set of existing homes that are known to be either in flood zones or not in flood zones) and the model is then essentially tested on this new set of known data to determine its predictive accuracy. The actual outcomes are fed to the model to tune its algorithm(s), e.g., my minimizing an error function corresponding to the predicted outcomes.

The machine learning model generates its own algorithms. These algorithms can be classification type algorithms and regression type algorithms. A classification type algorithm maps a function of different input variables to a discrete output variable. For example, based on the colors of pixels in an image of a home, the home is predicted either to have a body of water on its property or not to have a body of water on its property. A regression type algorithm maps a function of different input variables to a quantity of a variable within a continuous range of values. For example, based on weather records at a location of a new home, the new home is predicted to have a 56 percent likelihood of flooding over the next 30 years.

A given machine learning model can employ both classification and regression type algorithms to generate a prediction. In some examples, a machine learning model aggregates multiple algorithms, including both classification type and regression type algorithms, to generate predictive output.

Once the model being built is scored, during the post-scoring phase outputs of the model being built are audited or monitored, and then the model is tuned accordingly. For example, during the post-scoring phase the model is provided with new data without known outcomes (e.g., new homes for which it is not known if they are in a flood zone), and the model's output predictions are tested. If inconsistencies in how the model being built predicts outcomes for two similarly situated new homes, the model being built can be tuned further, trained further, scored further, etc.

Once post-scoring is complete, the model is essentially built and can be tested and deployed.

Some of the model building or development phases described above can be broken down into one or more additional phases or subphases.

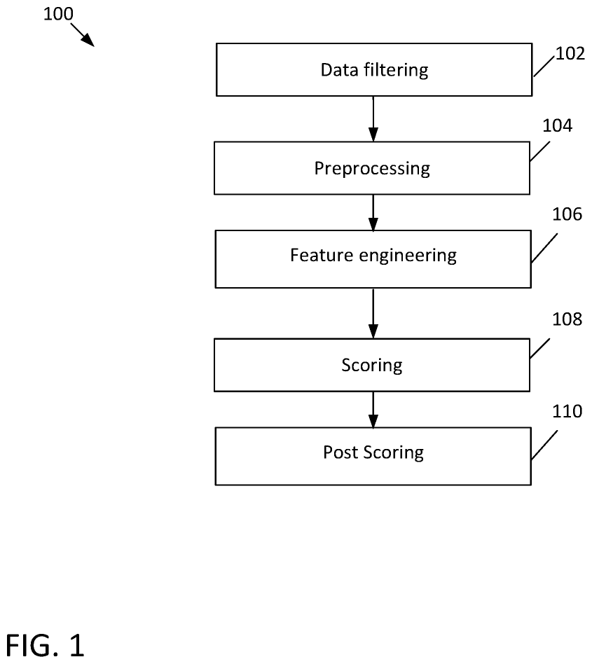

FIG. 1 shows an example machine learning model development method 100.

The method 100 includes a data filtering phase or step 102, a preprocessing phase or step 104, a feature engineering phase or step 106, a scoring phase or step 108, and a post scoring phase or step 110.

In some examples, the phases 102, 104 and 106 can all be parts or aspects of the training phase described above.

During the data filtering phase 102 of the method 100, relevancy of input data with respect to the desired predictive output of the machine learning model can be quantified. For example, certain data or data types can be determined to be irrelevant or of insignificant relevance to the predictive output desired to be obtained by the model being built, and such data is thereby simply discarded and not used to train the model being built. Thus, during the data filtering phase 102, insufficiently relevant input data is filtered out of the pool of data that is being used to train the model being built. For instance, at the step 102 it is determined that the number of stories above ground of a home is irrelevant to predicting whether the home is in a flood zone and so a portion of input data indicating the number of stories of homes is discarded and not a factor considered by the algorithm(s) of the machine learning model being built.

During the preprocessing phase 104, the filtered input data is further processed. For example, the format of the data is converted into another data format that can be processed by the machine learning model being built. For instance, the filtered input data can include images of homes known to be in flood zones or not in flood zones. During the preprocessing phase 104, the images can be converted into another data format, e.g., multi-dimensional vectors, which represent aspects or features of the images, such as the presence in the images of a body of water, like a pond or a stream.

During the feature engineering phase 106, variables from the filtered and pre-processed input data that are relevant to determining the predictive outcomes of the model being built are identified. In some examples, the variables can also be assigned weights according to their relevance. For example, the presence of a body of water is a variable determined to be relevant to whether a home is in a flood zone, and the variable is weighted (e.g., with a hyperparameter) according to how close to the home the body of water is (e.g., the closer to the home the body of water is, the greater the weight), the type of the body of water (e.g., a pond, a stream, an ocean), and the relative elevation of the home to the body of water. In some examples, data scientists can participate in the feature engineering phase 106, e.g., by suggesting potentially relevant variables for the model being built to use in its algorithms.

During the scoring phase 108, a performance of the machine learning model being built is measured by comparing predicted outcomes generated by the model being built to known data as described above.

During the post-scoring phase 110, outputs of the model being built are audited or monitored as described above, and tuning or algorithm adjustments can be made. For example, based on inconsistencies in predictive output determined from auditing the model being built, multiple learning algorithms generated by the model being built can be combined or aggregated to improve the predictive performance of the model being built. This aspect of the post-scoring phase 110 can sometimes be referred to as post-scoring aggregation.

In some examples, the models can use machine learning algorithms, such as linear regression, logistic regression, support vector machines, and neural networks.

In some examples, the models can use Bayesian networks and/or other machine learning algorithms to identify new and statistically significant data associations and apply statistically calculated confidence scores to those associations, whereby confidence scores that do not meet a predetermined minimum threshold are eliminated. Bayesian networks are algorithms that can describe relationships or dependencies between certain variables. The algorithms calculate a conditional probability that an outcome is highly likely given specific evidence. As new evidence and outcome dispositions are fed into the algorithm, more accurate conditional probabilities are calculated that either prove or disprove a particular hypothesis. A Bayesian network essentially learns over time.

Machine learning models can be supervised or unsupervised using statistical methods.

Machine learning models can learn to infer classifications. This can be accomplished using data processing and/or feature engineering to parse data into discrete characteristics, identifying the characteristics that are meaningful to the model, and weighting how meaningful or valuable each such characteristic is to the model such that the model learns to accord appropriate weight to such characteristics identified in new data when predicting outcomes.

In some examples, while the machine learning model is being built, the model can use vector space and clustering algorithms to group similar data inputs. When using vector space and clustering algorithms to group similar data, the data can be translated to numeric features that can be viewed as coordinates in a n-dimensional space. This allows for geometric distance measures, such as Euclidean distance, to be applied. There is a plurality of different types of clustering algorithms than can be selected. Some cluster algorithms such as K-means work well when the number of clusters is known in advance. Other algorithms such as hierarchical clustering can be used when the number of clusters is unclear in advance. An appropriate clustering algorithm can be selected after a process of experimental trial and error or using an algorithm configured to optimize selection of a clustering algorithm.

In some examples, machine learning models can be packaged together as a package that integrates and operatively links the models together. For example, the output of one model can serve as the input for another model in the package. Data is fed to the package of models and the models work together to generate outputs, such as predicted outcomes, which can be used by the enterprise, typically to improve their business in some way. For example, the model outputs can be used to improve the enterprise's profitability, to improve the enterprise's cost of customer acquisition, to improve the enterprise's customer relations, to identify a market in which to enter or expand, to identify a market in which to contract or from which to leave, and so forth.

Machine learning models are built with model tools that perform tasks. The tasks are associated with the different phases of model development. For example, machine learning model tools can include one or more tools that can perform aspects of data filtering as described herein. Machine learning model tools can include one or more tools that can perform aspects of data preprocessing as described herein. Machine learning model tools can include one or more tools that can perform aspects of feature engineering as described herein. Machine learning model tools can include one or more tools that can perform aspects of model scoring as described herein. Machine learning model tools can include one or more tools that can perform aspects of model post-scoring as described herein.

For each phase or subphase of a machine learning model's development, the correct tool to use can depend on the type of machine learning model, the type of predictive output (e.g., classification, regression, both), whether the machine learning model is packaged with one or more other machine learning models and, if so, what data is fed from one model to another, whether the machine learning model is supervised or unsupervised, and so forth.

For example, different model development tools may be needed at different development phases for supervised models than for unsupervised models. Different model development tools may be needed at different development phases for neural networks than for non-neural networks. Different model development tools may be needed for different types of neural networks at different development phases. For example, different tools may be needed for convolutional neural networks than for recurrent neural networks.

In some examples a data scientist determines these broad structural aspects of a machine learning model to be built (e.g., whether it is a neural network and, if so, what type of neural network, whether it is supervised or unsupervised, etc.). Once the structure of the model is configured, software engineering using the appropriate machine learning model building tools is performed to actually build the model according to the predefined structure.

Data scientists are often not software engineers. In addition, data scientists are often contract workers external to the enterprise that hires them. Such data scientists often use their own hardware and software to design machine learning models for an enterprise. Data scientists who design machine learning models may source model building tools from multiple different sources, e.g., multiple different companies or databases that provide machine learning model software tools.

Thus, a given enterprise may operate a suite of machine learning models that are built with many different types of model tools sourced from many different model component sources. The model tools may be not cross-compatible or incompatible with hardware, middleware or software of the enterprise that relies on the machine learning models.

As a result, managing, updating, and modifying the machine learning models can be highly time consuming, as the model tools that perform the model's various tasks and that were used to build the model initially are not standardized from model to model, further resulting in a high number of software engineering hours needed to manage a suite of machine learning models operated by the enterprise. For example, significant resources and time may need to be expended to convert tools of machine learning models into formats that are compatible with the enterprise's computing infrastructure.

The present disclosure advantageously provides an enterprise-specific standardized library of machine learning model building tools, or components, which are automatically accessed via an Application Programming Interface (API) while data scientists design machine learning models for an enterprise.

A specific software development kit (SDK) can be provided to allow model developers to use tools of the SDK to build machine learning models with tools from the library. In some examples, the SDK can be provided in a general-purpose programming language such as Python™. The SDK can be accessed by model developers without invoking an API. In some examples, the SDK can include an API.

Advantageously, the same suite of standardized tools can be used to build machine learning models regardless of the type of model, the building phase of the model, or the software used by the data scientist who initially designs the model at a high level.

The standardized tools of the present disclosure are used to build the enterprise's machine learning models, improving consistency of construction across the enterprise's models, and significantly reducing the amount of software engineering time needed to manage the models once they are built (e.g., for purposes testing models, deploying models, and fixing bugs in models).

These example improvements result in one or more practical applications of the disclosed technology. Additional advantages and improvements will be apparent from the present disclosure.

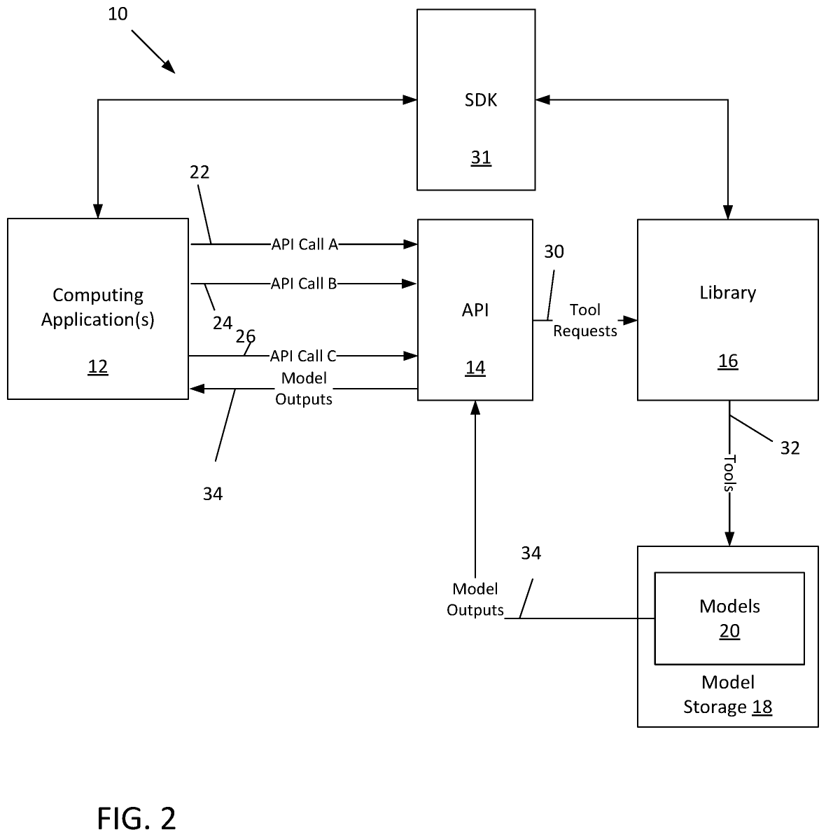

FIG. 2 shows an example system 10 for building machine learning models according to the present disclosure.

The system 10 includes one or more computer application(s) 12, an API 14, an SDK 31, a library 16, and a model storage 18 that stores machine learning models 20.

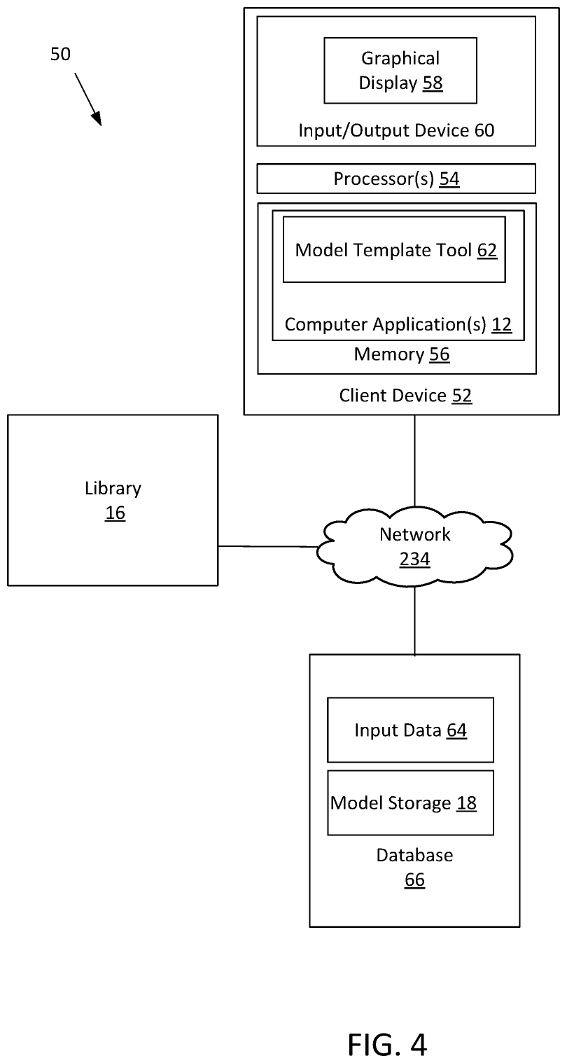

The different components of the system 10 are in operative communication with one another, e.g., via a network, such as the network 234 (FIG. 4).

The computer applications 12 are user facing computer applications. For example, the computer applications 12 are used by data scientists who design machine learning models for an enterprise. Different computer applications 12 may be used to design machine learning models for an enterprise depending on, for example, the particular data scientists or the particular type of machine learning model being designed.

One or more of the computer applications 12 can generate user interfaces via an input/output device. For example, such user interfaces can include templates that can be used by data scientists to design machine learning models. Examples of such templates are shown and described in the '478 Application.

Based on commands or prompts received via user interfaces of the computer application(s), calls from the computer applications 12 to the API 14 are generated.

Using the computer applications 12, model developers can access tools of a specifically formulated SDK 31 to build machine learning models with the library 16. The SDK 31 can be accessed by model developers to build the connection between the computing applications 12 and the library 16 through the API 14. In some examples, the SDK can be provided in a general-purpose programming language such as Python™.

In some examples, a computer application 12 is fitted with a software extension (e.g., a plug-in) that configures the computer application 12 to make calls specifically to the API 14 or in response to prompts or commands received at user interfaces of the computer application 12.

The API 14 enables the computer applications 12 to communicate with the library 16 and the models 20. In some examples, the API 14 includes a proxy layer that hides underlying functionality and identification of the library 16 and the model storage 18 from the computer applications 12. For example, if the library 16 is updated with model building tools or revised model building tools, the API acts as a proxy for the library 16 such that the updates do not significantly or noticeably modify the user experience of the computer applications 12. Moreover, data scientists using the computer applications 12 are shielded by the API 14 from knowing what tools (e.g., what tools from the library 16) are used to construct machine learning models they are designing.

As shown in FIG. 2, example call outs 22, 24 and 26 are made from the computer applications 12 to the API 14. Callouts can also be made from the computer applications 12 to the library 16 via one or more software writing tools of the SDK 31, which in some examples can include the API 14.

The callout 22 is a request for a tool needed for a given phase of model development for a first machine learning model.

The callout 24 is a request for a different tool needed for a different phase of model development for the first machine learning model, or a for a second machine learning model that is different from the first machine learning model.

The callouts 22 and 24 are both generated using one of the computer applications 12.

The callout 26 is a request for a model tool needed for a phase of a model development for yet another machine learning model. In this case, the callout 26 is generated using a different computer application 12 than that used to generate the callouts 22 and 24.

Thus, as shown in FIG. 2, the same API serve(s) as an interface between the library 16 on the one hand, and multiple different computer applications 12 making request for tools associated with multiple different machine learning models and tools needed for different development phases of different machine learning models.

Based on the API calls 22, 24, and 26, the API 14 sends different tool requests 30 to the library 16.

The library 16 is a repository of tools 32 used to build machine learning models, such as the tools described above. Based on the different API calls 22, 24, 26 and tool requests 30, different tools 32 stored in the library 16 are retrieved and provided to model storage 18, where machine learning models 20 are stored.

Outputs 34 (e.g., predictions generated by algorithms) of the machine learning models 20 can be provided back to the computer applications 12. In some examples, the model outputs 34 are provided back to the computer application 12 via the API 14. In other examples, the model outputs 34 can be provided back to the computer applications 12 via other routing paths. The computer applications 12 can then interface with the models 20 that are built or are still being built, e.g., for the purposes of testing performance of the models 20.

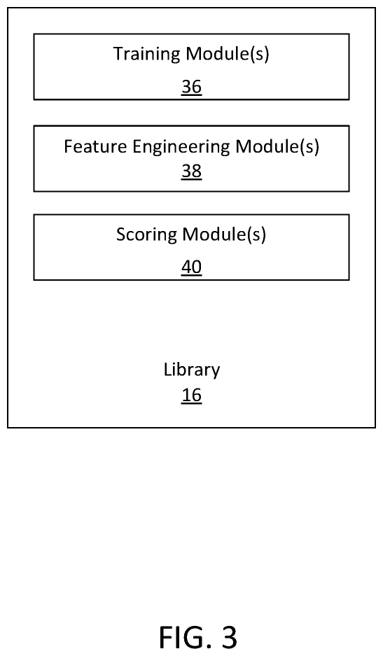

FIG. 3 shows details of the library 16 of the system 10 of FIG. 2.

The library 16 is a standardized repository of modules programmed to perform tasks of tools of different machine learning models, such as the tasks of the tools described above with reference to the different phases of machine learning model building or development.

In the example library 16 shown in FIG. 3, the library 16 includes one or more training modules 36, one or more feature engineering modules 38, and one or more scoring modules 40.

The training modules 36 can include tools configured to train different types of machine learning models, e.g., with different tools used for performing training tasks for different machine learning models, such as input data filtering tasks and input data format conversion tasks.

The feature engineering modules 38 can include tools configured to perform tasks associated with feature engineering of different algorithms of different machine learning models. For example, the feature engineering modules 38 can include tools configured to perform tasks of identifying variables from different sets of input data that are relevant to determining predicted outcomes by the machine learning models and, thereby, assist in constructing the algorithms of the machine learning models being built.

The scoring modules 40 can include tools configured to perform tasks associated with scoring of different machine learning model algorithms. For example, the scoring modules 40 can be configured to perform tasks of measuring performances of different machine learning models while the different machine learning models are being built by comparing predicted outcomes generated by the machine learning models being built to known data.

The library 16 can include other modules as well, such as post-scoring modules, testing modules, production modules and so forth, which can be configured with the tools that are used in such later phases of machine learning model lifetimes.

FIG. 4 shows a further example system 50 for building machine learning models according to the present disclosure. The system 50 includes components of the system 10 (FIG. 2), such as the library 16, the model storage 18 and the computer applications 12.

The system 50 includes a client device 52 and a database 66.

The database 66 can be a single storage or distributed storage across multiple locations. The database 66 can include non-transitory computer-readable storage.

The database 66 stores the model storage 18 and input data 64.

The input data 64 includes any data that may be used by the machine learning models being built, such as training data generally relevant to the predictions machine learning models being built are designed to output. That is, the input data 64 can be used by, e.g., modules of the library 16 and/or models stored on the model storage 18.

The input data 64 can be internally sourced and/or externally sourced. For example, the input data 64 can include internal proprietary data of the enterprise, such as data about past homes and home mortgages issued by a financial institution, as well as data about new homes and prospective mortgages. The input data 64 can include external (e.g., public) data, such as data available over the internet from other databases, such as government operated databases, service provider operated databases, and other databases.

In some examples, all of the components of the client device 52 are incorporated in a single local device or terminal of a user, e.g., a stakeholder of a financial institution or a data scientist contracting with the financial institution. In other examples, components of the client device 52 can be distributed among one or more local devices and/or one or more remote devices such as a server that communicates with the local device via the network 234. For instance, the memory 56 or a portion of the memory 56 can be stored on a server while the input/output (I/O) device 60 is a component of s different device, e.g., a client terminal.

In examples that include a server, in some instances the server device can be a private server, e.g., of a financial institution or other enterprise. In other instances, the server can be a shared server, such as a cloud to which users (e.g., data scientists) of a given enterprise have selective, private access.

The following description of FIG. 4 assumes that the client device 52 is a single device, such as a local server of a financial institution.

The client device 52 is configured to run the computer applications 12, which are described above. The client device 52 generates user interfaces via the graphical display 58 of the I/O device 60.

For example, templates for building and operating machine learning models, such as the templates described in the '478 Application, can be generated using the model template tool 62, which can be one of the computer applications 12 stored in the memory 56, or a component of one of the computer applications 12. For instance, the model template tool 62 can correspond, in some examples, to the model automation framework (MAF) driver of the '478 Application.

The client device 52 includes one or more processor(s) 54 configured to process data and execute computer readable instructions stored on the memory 56, for performing functions of the client device 52 described herein. For example, the processor(s) 54 can be configured to carry out functionality of the computer applications 12, including the model template tool 62.

User interfaces (e.g., graphical user interfaces) are generated using the computer applications 12 and displayed using the input/output (I/O) device 60, and particularly the graphical display 58 of the I/O device 60, which is configured to display user interfaces generated by the computer applications 12. The I/O device 60 can also include, for example, one or more of a touch screen, a microphone, a speaker, a stylus, a pen, a mouse and so forth.

The memory 56 includes non-transitory computer-readable storage.

The database 66 can be a portion of the memory 56 or remote therefrom.

The database 66, the library 16, and the client device 52 are in operative communication with one another via the network 234.

The client device 52 interfaces with the library 16 and the model storage 18 via the API 14 (FIG. 2).

Machine learning models being built can be stored in the model storage 18 and access in the input data 64, e.g., via the network 234.

Via the network 234, commands or prompts entered, e.g., by a data scientist into a user interface displayed on the graphical display 58 can automatically generate calls to the API 14 (FIG. 2). The calls can be structured differently from one another depending on the types of prompts or commands entered (e.g., depending on the type of associated machine learning model being built and/or the corresponding development phase of the machine learning model being built). For example, the calls that are automatically generated can be tagged according to these and other aspects of the machine learning models being built.

In response to the different calls, the appropriate tools from the standardized library 16 of machine learning model development tools are retrieved from the library to build the machine learning model, phase by phase. For example, at each successive phase of building a machine learning model, the data scientist provides further commands that automatically generate corresponding calls that retrieve the tools from the library 16 needed for those phases of that model.

The network 234 can be any suitable data network, such as the internet, a wide area network, a local area network, a wired network, a wireless network, a cellular network, a satellite network, a near field communication network, or any operatively connected combination of these.

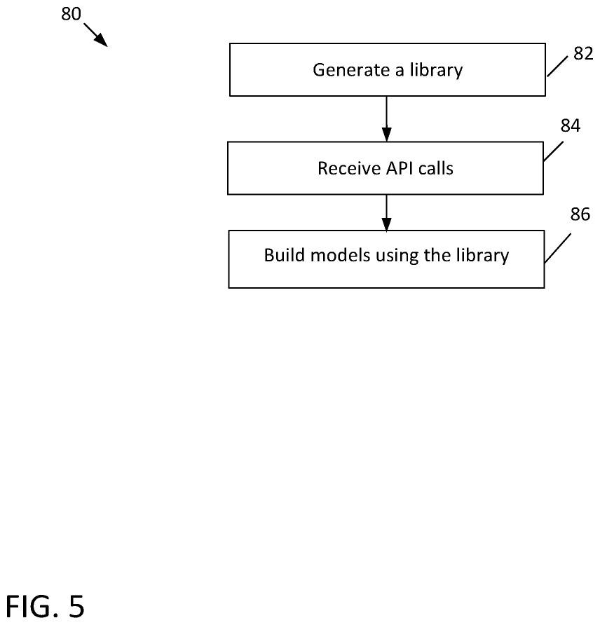

FIG. 5 shows an example method 80 of building machine learning models according to the present disclosure.

At a step 82 of the method 80, a standardized library of machine learning model building tools is generated. For example, the library 16 of FIG. 2 is generated at the step 82. The library 16 can be proprietary or otherwise exclusive to a given enterprise, such as a financial institution. The library 16 includes modules programmed to perform different tasks of different phases of different types of machine learning models.

At a step 84 of the method 80, calls to the library generated at the step 82 are received. For example, calls are made via the API 14 (FIG. 2).

At a step 86 of the method 84, the calls retrieve the tools from the library needed to perform specific tasks of specific phases of the machine learning models being built. The calls can be one or more of model-type specific, model building phase specific, module specific, tool specific, and/or task specific. Using the corresponding tools retrieved from the library via the calls, the machine learning models are built.

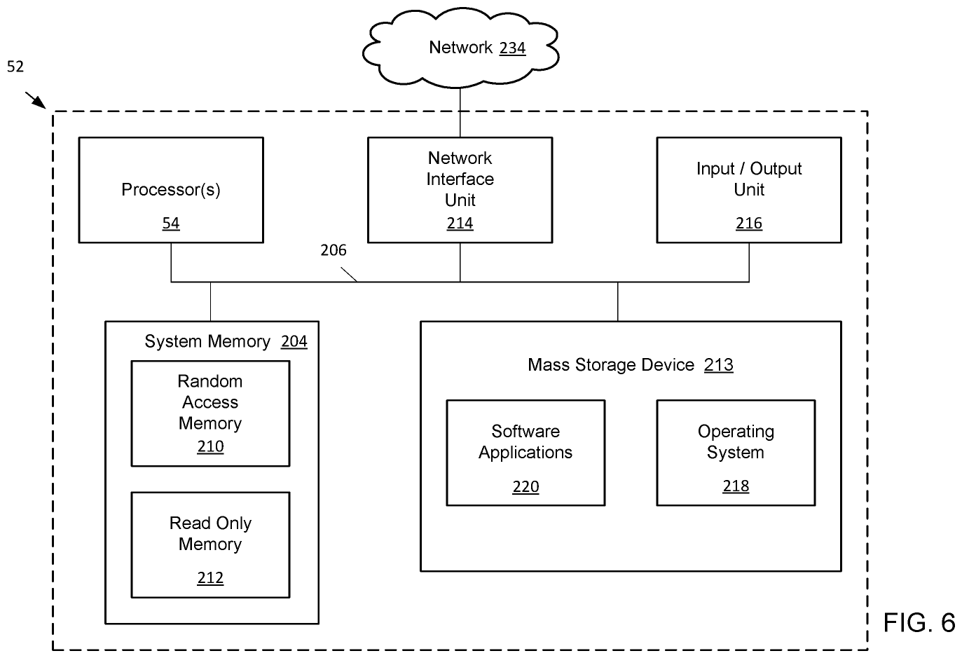

Additional components of the client device 52 are illustrated in FIG. 6. In this example, the client device 52 provides the computing resources to perform at least some of the functionality associated with the system 10 (FIG. 1) and the system 50 (FIG. 4).

The client device 52 can be an internally controlled and managed device (or multiple devices) of an enterprise. Alternatively, the client device 52 can represent one or more devices operating in a shared computing system external to the enterprise, such as a cloud. Further, the other computing devices disclosed herein can include the same or similar components.

Via the network 234, any components of the client device 52 that are physically remote from one another can interact with one another, as well as with other computing resources, such as those shown in FIGS. 2 and 4.

The client device 52 includes the processor(s) 54, a system memory 204, and a system bus 206 that couples the system memory 204 to the processor(s) 54.

The system memory 204 includes a random access memory (“RAM”) 210 and a read-only memory (“ROM”) 212. A basic input/output system that contains the basic routines that help to transfer information between elements within the client device 52, such as during startup, is stored in the ROM 212.

The client device 52 further includes a mass storage device 213. The mass storage device 213 can correspond to the memory 56, the library 16, and/or the database 66 (FIG. 4). The mass storage device 213 is able to store software instructions and data, such as modules of the library 16 and the computer applications 12 (FIG. 4).

The mass storage device 213 is connected to the processor(s) 54 through a mass storage controller (not shown) connected to the system bus 206. The mass storage device 213 and its associated computer-readable data storage media provide non-volatile, non-transitory storage for the client device 52. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the client device 52.

According to various embodiments of the invention, the client device 52 may operate in a networked environment using logical connections to remote network devices (such as computing resources shown in FIGS. 1 and 4) through the network 234, such as a wireless network, the internet, or another type of network. The client device 52 may connect to the network 234 through a network interface unit 214 connected to the system bus 206. It should be appreciated that the network interface unit 214 may also be utilized to connect to other types of networks and remote computing systems. The client device 52 also includes an input/output unit 216 for receiving and processing input from a number of other devices, including a touch user interface display screen, an audio input device, or another type of input device. Similarly, the input/output unit 216 may provide output to a touch user interface display screen or other type of output device, including, for example, the I/O device 60 (FIG. 4).

As mentioned briefly above, the mass storage device 213 and/or the RAM 210 of the client device 52 can store software instructions and data. The software instructions include an operating system 218 suitable for controlling the operation of the client device 52. The mass storage device 213 and/or the RAM 210 also store software instructions and applications 220, that when executed by the processor(s) 54, cause the client device 52 to provide functionality of the system 10 and the system 50 described above (FIGS. 2 and 4).

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computing system for generating models, comprising:
a processor; and
memory encoding instructions which, when executed by the processor, cause the computing system to:
store a library including modules, the modules being programmed to perform tasks of tools of different machine learning models; and
incorporate different ones of the modules into the different machine learning models while the different machine learning models are being built, the different ones of the modules being incorporated into the different machine learning modules in response to different calls made via an Application Programming Interface (API), the API being an interface between the library and a computer application configured to receive commands for building the different machine learning models.

2. The computing system of claim 1, wherein the memory encodes further instructions which, when executed by the processor, cause the processor to:
using the different machine learning models, predict outcomes based on data inputs.

3. The computing system of claim 1,
wherein the tools include a training tool; and
wherein the tasks include a task of the training tool that provides input data to a machine learning model being built to train the machine learning model being built.

4. The computing system of claim 1,
wherein the tools include a data filtering tool; and
wherein the tasks include a task of the data filtering tool that discards a portion of input data.

5. The computing system of claim 1,
wherein the tools include a preprocessing tool; and
wherein the tasks include a task of the preprocessing tool that converts input data having a data format into another data format that can be processed by a machine learning model being built.

6. The computing system of claim 1,
wherein the tools include a feature engineering tool; and
wherein the tasks include a task of the feature engineering tool that identifies variables from input data that are relevant to determining predicted outcomes by a machine learning model being built.

7. The computing system of claim 1,
wherein the tools include a scoring tool; and
wherein the tasks include a task of the scoring tool that measures a performance of a machine learning model being built by comparing predicted outcomes generated by the machine learning model being built to known data.

8. The computing system of claim 7,
wherein the scoring tool includes a classification tool; and
wherein the tasks include a task of the classification tool that maps a function of input variables learned by the machine learning model being built to one or more discrete output variables corresponding to the predicted outcomes.

9. The computing system of claim 7,
wherein the scoring tool includes a regression tool; and
wherein the tasks include a task of the regression tool that maps a function of input variables learned by the machine learning model being built to a continuous output variable corresponding to the predicted outcomes.

10. The computing system of claim 1, further comprising a software development kit operable with a plurality of differently configured computer applications each of which is configured to receive commands for building the different machine learning models using tools of the software development kit.

11. A method of generating computer-implemented models, comprising:
storing a library including modules, the modules being programmed to perform tasks of tools of different machine learning models; and
incorporating different ones of the modules into the different machine learning models while the different machine learning models are being built, the different ones of the modules being incorporated into the different machine learning modules in response to different calls made via an Application Programming Interface (API), the API being an interface between the library and a computer application configured to receive commands for building the different machine learning models.

12. The method of claim 11, further comprising:
using the different machine learning models, predicting outcomes based on data inputs.

13. The method of claim 11,
wherein the tools include a training tool; and
wherein the tasks include a task of the training tool that provides input data to a machine learning model being built to train the machine learning model.

14. The method of claim 11,
wherein the tools include a data filtering tool; and
wherein the tasks include a task of the data filtering tool that discards a portion of input data.

15. The method of claim 11,
wherein the tools include a preprocessing tool; and
wherein the tasks include a task of the preprocessing tool that converts input data having a data format into another data format that can be processed by a machine learning model being built.

16. The method of claim 11,
wherein the tools include a feature engineering tool; and
wherein the tasks include a task of the feature engineering tool that identifies variables from input data that are relevant to determining predicted outcomes by a machine learning model being built.

17. The method of claim 11,
wherein the tools include a scoring tool; and
wherein the tasks include a task of the scoring tool that measures a performance of a machine learning model being built by comparing predicted outcomes generated by the machine learning model being built to known data.

18. The method of claim 11, wherein a software development kit is operable with a plurality of differently configured computer applications each of which is configured to receive commands for building the different machine learning models using tools of the software development kit.

19. A computing system for generating models, comprising:
a processor; and
memory encoding instructions which, when executed by the processor, cause the computing system to:
store a library including modules, the modules being programmed to perform tasks of tools of different machine learning models, the library including:
at least one first module configured to filter out and discard portions of input data while the different machine learning models are being built;
at least one second module configured to convert different sets of input data having data formats into other data formats that can be processed by the machine learning models while the machine learning models are being built;
at least one third module configured to identify variables from the different sets of input data that are relevant to determining predicted outcomes by the machine learning models while the machine learning models are being built; and
at least one fourth module configured to measure performances of the different machine learning models while the different machine learning models are being built by comparing the predicted outcomes generated by the machine learning models being built to known data; and
incorporate the modules into the different machine learning models while the different machine learning models are being built, the modules being incorporated into the different machine learning modules in response to different calls made via an Application Programming Interface (API), the API being an interface between the library and a computer application configured to receive commands for building the different machine learning models.

20. The computing system of claim 19, wherein the API is configured to interface between the library and a plurality of differently configured computer applications each of which is configured to receive commands for building the different machine learning models.
